(19) United States
(12) Patent Application Publication
(10) Pub. No.: US 2024/0045074 A1
(43) Pub. Date: Feb. 8, 2024

(54) METHOD FOR MONITORING AND CONSOLIDATING A SATELLITE NAVIGATION SOLUTION

(71) Applicant: THALES, COURBEVOIE (FR)

(72) Inventors: Denis BOUVET, VALENCE (FR); Roland BONEL, VALENCE (FR); Christian MEHLEN, Etoile sur Rhône (FR)

(21) Appl. No.: 18/267,073

(22) PCT Filed: Dec. 14, 2021
(86) PCT No.: PCT/EP2021/085581

§ 371 Date: Jun. 13, 2023

(30) Foreign Application Priority Data
Dec. 17, 2020 (FR) 2013481

(51) Int. Cl. G01S 19/20

(52) U.S. Cl. CPC G01S 19/20

(57) ABSTRACT

A consolidation method implementing: a first sensor able to determine a computed position \hat{x}⁽¹⁾ of the aircraft, a characterization of the positioning error and a horizontal protection level HPL⁽¹⁾, a second sensor, with a different design and with a design level equivalent to the first sensor, able to determine a second position \hat{x}⁽²⁾ of the aircraft and a characterization of the positioning error of the second position \hat{x}⁽²⁾, and comprising the steps: a. estimating a horizontal deviation between the computed position \hat{x}⁽¹⁾ and the second position \hat{x}⁽²⁾, b. comparing the horizontal deviation with a detection threshold, c. if the horizontal deviation is below the detection threshold, computing an additional horizontal protection level HPL^{(MON)} of the computed position \hat{x}⁽¹⁾, d. estimating a consolidated horizontal protection level HPL^{(CON)}, e. comparing the consolidated horizontal protection level HPL^{(CON)} and a horizontal alert limit HAL, f. if the consolidated horizontal protection level HPL^{(CON)} is less than the horizontal alert limit HAL, horizontally confirming the computed position \hat{x}⁽¹⁾.

### CROSS-REFERENCE TO RELATED APPLICATIONS

This application is a National Stage of International patent application PCT/EP2021/085581, filed on Dec. 14, 2021, which claims priority to foreign French patent application No. FR 2013481, filed on Dec. 17, 2020, the disclosures of which are incorporated by reference in their entirety.

### FIELD OF THE INVENTION

The present invention relates to the field of satellite navigation applied to aeronautics. More specifically, the invention relates to a method and a device for monitoring the position of an aircraft in real time and for consolidating this position by means of satellite navigation.

### BACKGROUND

Current GNSS (Global Navigation Satellite System) systems (Navstar GPS, GLONASS, GALILEO, Beidou, etc.) allow the position of an aircraft to be determined and a level of precision of approximately one meter to be obtained, but they currently do not allow the precision of the computed position to be guaranteed. For example, if a GNSS receiver uses the information from a defective satellite, the computed position can then deviate by a few meters up to several kilometers from the actual position of the aircraft, potentially causing dangerous situations in specific cases. Typically, this can be during PA (Precision Approach) operations translating, for example, approach phases for a close landing in which the aircraft uses lateral guidance and vertical guidance from the data of the GNSS systems. During these PA operations, the aircraft therefore requires enhanced precision. Thus, an error in the positioning of the aircraft during these critical flight phases can lead to dangerous situations.

A decision then can be made to combine an augmentation system with the GNSS systems. The augmentation system allows the integrity of the information to be guaranteed. There are currently three principles for augmenting the GNSS:
The ABAS (Airborne Based Augmentation System) system.
The SBAS (Space Based Augmentation System) system.
The GBAS (Ground Based Augmentation System) system.

An item of GNSS equipment computes, based on the satellite measurements, a three-dimensional position that can be used for navigation and/or approach aeronautical operations. Generally, the item of GNSS equipment associates precision and integrity intervals with this position that allow the navigation system to determine the feasibility of the operation by comparing these indicators with limit values. Thus, the limit values in terms of integrity are called alert limits (AL), and the integrity intervals are called protection levels (PL). The latter are determined by taking into account a certain number of parameters, such as the allocation of Signal-In-Space (SIS) integrity of the operation or even the failure rates of the satellites used by the GNSS equipment.

The Signal-In-Space (SIS) standards thus characterize the performance requirements for each civil operation in accordance with different approaches:
the continuity that corresponds to the capacity of the on-board system to be operated without an unplanned interruption throughout the whole of the study period. More specifically, this parameter can be understood to be the probability that the performance capabilities of the system are maintained throughout the whole of the flight phase,
the integrity that corresponds to the measurement of the confidence that can be placed in the positioning information provided by the navigation system. The integrity requirements are characterized by the following parameters:
   a horizontal alert limit (HAL) that corresponds to the maximum horizontal position error beyond which the navigation system must be considered to be inoperable,
   a vertical alert limit (VAL) that corresponds to the maximum vertical position error beyond (above or below) which the navigation system must be considered to be inoperable,
   an integrity risk P_{HMI} that corresponds to the probability that the error concerning the positioning of the aircraft exceeds horizontal and/or vertical protection levels without the user of the navigation system being alerted as such. By way of an example, the integrity risk P_{HMI} can be equivalent to a probability of 10⁻⁷ representing the probability of a hazardous event in aeronautics.

All these parameters are defined as a function of the ongoing operation, such as, for example, landing the aircraft or the en route navigation phase. All these operations are classified and numerous design constraints on the on-board equipment depend on this classification. Thus, a second requirement classification related to the GNSS equipment can be introduced where the criticality level takes precedence. This second classification or FDAL (Functional Development Assurance Level) thus specifies the development constraints linked to acquiring a certified avionics component. This FDAL classification is made up of five criticality levels denoted from A (the most critical) to E (the least critical).

Thus, an item of GNSS equipment combined with an ABAS system intended for lateral navigation operations for which the criticality of the integrity failure is considered to be significant can be associated with a level C FDAL. An item of GNSS equipment used for category I approach operations for which the criticality of the integrity failure is considered to be hazardous can be associated with a level B FDAL. Finally, an item of GNSS equipment used for category III approach operations for which the criticality of the integrity failure is considered to be catastrophic can be associated with a level A FDAL.

However, the cost associated with the design of an aeronautical component responding to the FDAL level (criticality level) for which the component must be certified increases with the criticality level. Thus, an aeronautical component defined by a level D FDAL is less expensive in terms of design compared to another component defined by a level A FDAL.

Furthermore, it is not always possible to develop an aeronautical component at the FDAL level that is required for the operation. Nevertheless, it is possible to combine several components with a lower FDAL level in order to replace a component with a higher FDAL level, allowing the operation to be carried out by installing a device for monitoring one component with another component.

Thus, by way of an example of a possible application, for a function requiring an avionics component with criticality that requires a level C FDAL, a person skilled in the art can choose to use the measurement of a second component or sensor with a level D FDAL criticality level and to compare the data acquired from this second component with the measurement from a third component or sensor with a different design from the second component, i.e. the third avionics component receives data different from the data received by the second component and operates differently compared with the second avionics component, while transferring a measurement equivalent to the measurement determined by the second avionics component, and with an equivalent design or criticality level, i.e. a level D FDAL. Thus, a person skilled in the art can decide to interrupt the operation of the avionics equipment based on the measurements determined by the second and the third components if the two acquired measurements are not consistent with each other.

However, this solution cannot always be implemented, for example when an aircraft cannot be equipped with GNSS receivers with a different design. In particular, this is the case for a receiver using data originating from the satellites of a second constellation, for example Glonass or Galileo, that, compared with GPS satellites, does not allow horizontal and vertical protection levels to be acquired that are equivalent to the protection levels acquired by a sensor using data originating from GPS satellites augmented by an ABAS, SBAS or GBAS augmentation system.

### SUMMARY OF THE INVENTION

The aim of the invention is to overcome all or some of the aforementioned problems by proposing a method for consolidating a position of an aircraft by satellite navigation allowing a computation to be provided of a second horizontal and vertical protection level that is reliable with respect to any erroneous data provided by an avionics sensor. By means of this mechanism, it is possible to claim a higher level of operational development assurance of the avionics sensors for the position and for the associated protection levels.

The invention also allows the level of protection of a first avionics sensor to be consolidated, even if the failure rates of the satellites used by the second sensor do not allow autonomous protection levels to be computed for the measurement provided by the second sensor.

To this end, a subject of the invention is a method for consolidating a satellite navigation solution for an aircraft implementing:
a first sensor, comprising an augmentation system, able to determine a computed position \hat{x}⁽¹⁾ of the aircraft, a characterization of the positioning error of the computed position \hat{x}⁽¹⁾ and a horizontal protection level HPL⁽¹⁾ of the computed position \hat{x}⁽¹⁾,
a second sensor, with a different design to the first sensor and with a design level equivalent to the first sensor, able to determine a second position \hat{x}⁽²⁾ of the aircraft and a characterization of the positioning error of the second position \hat{x}⁽²⁾, the consolidation method comprising the following steps:
estimating a horizontal deviation between the computed position \hat{x}⁽¹⁾ of the aircraft and the second position \hat{x}⁽²⁾ of the aircraft,
comparing the horizontal deviation with a previously defined detection threshold,
if the horizontal deviation is below the detection threshold, computing an additional horizontal protection level HPL^{(MON)} of the computed position \hat{x}⁽¹⁾ from the second position \hat{x}⁽²⁾,
estimating a consolidated horizontal protection level HPL^{(CON)} as a function of the additional horizontal protection level HPL^{(MON)} and of the horizontal protection level HPL⁽¹⁾,
comparing the consolidated horizontal protection level HPL^{(CON)} and a previously defined horizontal alert limit HAL,
if the consolidated horizontal protection level HPL^{(CON)} is less than the horizontal alert limit HAL, horizontally confirming the computed position \hat{x}⁽¹⁾ of the aircraft.

According to one aspect of the invention, the consolidation method comprises an additional step, following the step of horizontally confirming the first position \hat{x}⁽¹⁾, of validating the computed position \hat{x}⁽¹⁾ of the aircraft as a consolidated position of the aircraft.

According to one aspect of the invention, the additional horizontal protection level HPL^{(MON)} is computed from the horizontal deviation between the computed position \hat{x}⁽¹⁾ of the aircraft and the second position \hat{x}⁽²⁾ of the aircraft and/or from the detection threshold of a positioning anomaly in the horizontal plane, and from the characterization of the positioning error of the second position \hat{x}⁽²⁾.

According to one aspect of the invention, the augmentation system of the first sensor is an Airborne Based Augmentation System (ABAS).

According to one aspect of the invention, the augmentation system of the first sensor is a Space Based Augmentation System (SBAS) or a Ground Based Augmentation System (GBAS).

According to one aspect of the invention, the first sensor is able to determine a vertical protection level VPL⁽¹⁾.

According to one aspect of the invention, the consolidation method comprises an additional step of computing an additional vertical protection level VPL^{(MON)} from a vertical deviation between the computed position \hat{x}⁽¹⁾ of the aircraft and the second position \hat{x}⁽²⁾ of the aircraft and/or from the detection threshold of a vertical positioning anomaly, and from the characterization of the positioning error of the second position \hat{x}⁽²⁾ following the step of computing the additional horizontal protection level HPL^{(MON)}.

According to one aspect of the invention, the consolidation method comprises an additional step of estimating a consolidated vertical protection level VPL^{(CON)} as a function of the additional vertical protection level VPL^{(MON)} and of the vertical protection level VPL⁽¹⁾ following the step of estimating the consolidated horizontal protection level HPL^{(CON)}, the consolidation method comprises an additional step of comparing the consolidated vertical protection level VPL^{(CON)} and a previously defined vertical alert limit VAL following the step of comparing the consolidated horizontal protection level HPL^{(CON)} and the previously defined horizontal alert limit HAL.

According to one aspect of the invention, the consolidation method comprises an additional step of vertically confirming the first position \hat{x}⁽¹⁾ if the consolidated vertical protection level VPL^{(CON)} is less than the vertical alert limit VAL following the horizontal confirmation step.

According to one aspect of the invention, the detection threshold is computed as a function of an allocation of continuity.

A further subject of the invention is a computer program product, said computer program comprising code instructions for carrying out the steps of the consolidation method when said program is executed on a computer.

A further subject of the invention is a processor-readable recording medium on which is recorded a program comprising instructions for executing the consolidation method when the program is executed by a processor.

A further subject of the invention is a device for consolidating a satellite navigation solution able to implement the consolidation method, comprising the first sensor comprising an augmentation system, able to determine a computed position \hat{x}⁽¹⁾ of the aircraft, a characterization of the positioning error of the computed position \hat{x}⁽¹⁾ and a horizontal protection level HPL⁽¹⁾, and the second sensor with a different design to the first sensor and with a design level equivalent to the first sensor, able to determine a second position \hat{x}⁽²⁾ of the aircraft and a characterization of the positioning error of the second position \hat{x}⁽²⁾.

### BRIEF DESCRIPTION OF THE DRAWINGS

The invention will be better understood and further advantages will become apparent upon reading the detailed description of an embodiment that is provided by way of an example, which description is illustrated by the accompanying drawing in which:

FIG. 1 shows a method for consolidating a satellite navigation solution for an aircraft according to the invention;

FIG. 2 shows the method for consolidating a satellite navigation solution for an aircraft according to an alternative embodiment of the invention;

FIG. 3 shows a device for consolidating a satellite navigation solution according to the invention.

For the sake of clarity, the same elements will use the same references throughout the various figures.

### DETAILED DESCRIPTION

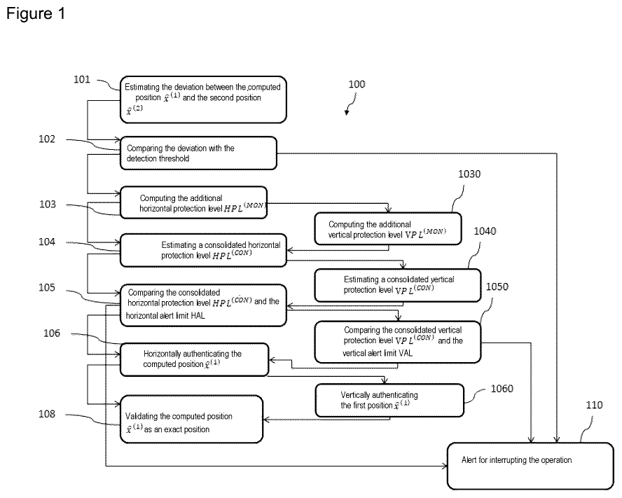

FIG. 1 shows a method 100 for consolidating a satellite navigation solution for an aircraft according to the invention. More specifically, the method 100 for consolidating the position of an aircraft is applicable within the context of operations for three-dimensionally detecting the position of an aircraft.

During an operation using the three-dimensional position originating from GNSS satellite measurements, an aircraft can comprise a first GNSS sensor and a second GNSS sensor with a different design and having an identical FDAL level allowing monitoring of the measurements carried out by the first GNSS sensor by comparing, for example, the measurements acquired in terms of position and/or deviation of the trajectory.

Both the first and the second sensor must comply with the standard related to the integrity risk P_{HMI}, i.e. must have a positioning error rate exceeding the protection levels of the first and second sensors below the required rate.

Thus, the first sensor is capable of associating a computed position \hat{x}⁽¹⁾ with a covariance matrix C⁽¹⁾ characterizing the positioning error of the computed position \hat{x}⁽¹⁾ associated with the stated Signal-In-Space standards, with a horizontal protection level (HPL⁽¹⁾) representing the horizontal assurance space in which the computed position \hat{x}⁽¹⁾ is included for a probability of 1−P_{HMI}. The horizontal protection level (HPL⁽¹⁾) spatially represents the radius of a circle on the horizontal plane comprising the computed position \hat{x}⁽¹⁾ according to a probability of approximately 1-10⁻⁷. The first sensor comprises an ABAS-type augmentation system. However, the first sensor can also comprise an SBAS- or GBAS-type augmentation system.

The first sensor optionally can be capable of providing a vertical protection level (VPL⁽¹⁾) representing the vertical assurance space in which the computed position \hat{x}⁽¹⁾ is included for a probability that is close to one hundred percent using the augmentation system that complies with the standard related to the integrity risk P_{HMI}.

The second sensor is capable of providing an estimate of a second position \hat{x}⁽²⁾ as well as a covariance matrix C⁽²⁾ characterizing the positioning error of the associated second position \hat{x}⁽²⁾ as a function of the stated Signal-In-Space standards.

The second sensor is not necessarily capable of associating the estimate of the second position \hat{x}⁽²⁾ with the horizontal and vertical protection levels due, for example, to it being impossible to implement an augmentation system guaranteeing the allocation of integrity P_{HMI}. Nevertheless, the second sensor may be able to provide these levels of protection if it can perform this action in compliance with the Signal-In-Space standards and, more specifically, while complying with the integrity risk P_{HMI}.

By way of an example, the first GNSS sensor can be a GPS sensor exclusively communicating with the constellation of GPS satellites. Indeed, with the positioning error rate or the failure rate of one or more GPS satellites not influencing the first sensor, augmented by an augmentation system, to exceed the standard related to the integrity risk P_{HMI}, the GPS sensor can provide a horizontal protection level (HPL⁽¹⁾) and, optionally, a vertical protection level (VPL⁽¹⁾). The second GNSS sensor can be a sensor exclusively communicating with a second constellation of satellites, for example Glonass or Galileo. However, in some cases, the failure rate of these satellites does not allow the second sensor to provide protective radii in accordance with the integrity risk P_{HMI}. Under these conditions, it is no longer possible for the second sensor to supply horizontal and vertical protection levels in real time in accordance with the Signal-In-Space standards and the integrity risk P_{HMI}. Thus, the second position \hat{x}⁽²⁾ may not be intrinsically integrated relative to the Signal-In-Space standards, since, in addition to the second position \hat{x}⁽²⁾, the positioning error of the second position \hat{x}⁽²⁾ only needs to be represented by the covariance matrix C⁽²⁾.

Indeed, by taking the example of the GPS sensor as the first sensor and the Glonass or Galileo sensor as the second sensor, the probability of a failure or of a positioning error of at least two satellites of the GPS constellation is of the order of 10⁻⁸, which is significantly lower than an integrity risk P_{HMI} of the order of 10⁻⁷ and proves that an event involving the failure of more than two satellites of the GPS constellation communicating with the first sensor or GPS sensor is unlikely to occur. Moreover, the probability of a failure or of a positioning error of a single satellite of the GPS constellation is approximately 10⁻⁵. Nevertheless, the augmentation system (ABAS, SBAS or even GBAS) included in the first sensor or GPS sensor allows the so-called erroneous satellite to be identified and thus allows the data originating from this so-called erroneous satellite to be separated from the processing of the first sensor or GPS sensor.

Conversely, the probability of a failure or of a positioning error of at least two satellites of the second constellation can be greater than the integrity risk P_{HMI}. This therefore implies that it is highly likely that at least two satellites of the second constellation can be so-called erroneous satellites, yet without being able to identify which. Thus, the second position \hat{x}⁽²⁾ can be considered to be poorly integrated but tolerated by the consolidation method 100 as long as the second position \hat{x}⁽²⁾ is accompanied by the uncertainty linked to this datum or the positioning error of the second position \hat{x}⁽²⁾ represented by the covariance matrix C⁽²⁾. Thus, the method 100 for consolidating a satellite navigation solution has the advantage of being able to integrate the monitoring of a first computed solution or position \hat{x}⁽¹⁾ of the aircraft with a second solution or second position \hat{x}⁽²⁾ not necessarily complying with the Signal-In-Space integrity standards.

The method 100 for consolidating a satellite navigation solution for an aircraft then comprises a step 101 of estimating a horizontal deviation, i.e. a deviation in the horizontal plane, of the distance between the computed position \hat{x}⁽¹⁾ of the aircraft computed by the first GNSS sensor and the second position \hat{x}⁽²⁾ of the aircraft computed by the second GNSS sensor.

This horizontal deviation allows translation, in the form of one absolute value to three absolute values, of a difference in the positioning of the aircraft according to the first and the second GNSS sensor. In general, the second GNSS sensor provides constant monitoring with respect to the first sensor or GPS sensor in order to be certain of the integrity of the computed position \hat{x}⁽¹⁾.

Thus, a significant horizontal deviation can translate an error in the positioning of the aircraft, and therefore alert the avionics components, and the crew interacting with these avionics components, of the alteration of the computed position \hat{x}⁽¹⁾ of the aircraft.

Conversely, a small horizontal deviation allows the computed position \hat{x}⁽¹⁾ to be confirmed by its coherence with the second position \hat{x}⁽²⁾ of the aircraft.

After having estimated this horizontal deviation during step 101, the method 100 for consolidating the satellite navigation solution compares (step 102) the estimated horizontal deviation with a previously defined detection threshold. The detection threshold is generally defined and computed on the basis of an allocation of continuity implemented as a function of the Signal-In-Space continuity standards and of the positioning errors of the computed position \hat{x}⁽¹⁾ and of the second position \hat{x}⁽²⁾. This allocation of continuity can be, for example, a probability that any operation defined by constraints in terms of continuity and integrity directly linked to the Signal-In-Space standards is interrupted due to a false alarm resulting from the satellite signal monitoring devices. This probability can be assessed as a function of the specifications and uncertainties of the sensors used or as a function of the specific features of the constellations of satellites communicating with the first and/or the second sensor. By way of an example, the error threshold can be determined as follows:

T=K_{fa}×σ_{inc}⁽¹⁾⁻⁽²⁾

Where T represents the detection threshold, K_{fa} represents the probability that the operation is interrupted because of a false alarm and σ_{inc}⁽¹⁾⁻⁽²⁾ represents the standard deviation between the two solutions, namely the computed position \hat{x}⁽¹⁾ and the second position \hat{x}⁽²⁾. Thus, this standard deviation can be computed as follows:

σ_{inc}⁽¹⁾⁻⁽²⁾=\sqrt{C⁽¹⁾+C⁽²⁾}

With C⁽¹⁾ being the covariance matrix representing the positioning error of the computed position \hat{x}⁽¹⁾ and C⁽²⁾ being the covariance matrix representing the positioning error of the second position \hat{x}⁽²⁾.

If the detection threshold is crossed, i.e. if the horizontal deviation between the computed position \hat{x}⁽¹⁾ and the second position \hat{x}⁽²⁾ is greater than the detection threshold, the method 100 for consolidating the solution triggers an alert (step 110) for interrupting the operation allowing an anomaly to be shown that is associated with the alteration of the computed position \hat{x}⁽¹⁾. This alert (step 110) then allows the ongoing operation to be interrupted directly. More specifically, when the alert (step 110) is triggered following the comparison step (step 102) between the estimated horizontal deviation and the detection threshold, it represents an incoherence linked to the computed position \hat{x}⁽¹⁾.

Conversely, if no anomaly is detected, i.e. if the detection threshold is not crossed, the method 100 for consolidating the solution allows computation (step 103) to be initiated of an additional horizontal protection level HPL^{(MON)} from the second position \hat{x}⁽²⁾ and the associated positioning uncertainty. The additional horizontal protection level HPL^{(MON)} is, like the horizontal protection level (HPL⁽¹⁾), a radius of a circle on the horizontal plane comprising the computed position \hat{x}⁽¹⁾ as a certain probability, on the basis of the second sensor and of the second position \hat{x}⁽²⁾. More specifically, the additional horizontal protection level HPL^{(MON)}, which is not the horizontal protection radius of the second position \hat{x}⁽²⁾ since it is not possible to verify the proper integrity of the second position \hat{x}⁽²⁾ in accordance with the integrity risk P_{HMI} due to the potential failure rates of a plurality of satellites communicating with the second sensor, is computed on the basis of the horizontal deviation between the computed position \hat{x}⁽¹⁾ and the second position \hat{x}⁽²⁾ estimated during step 101 and/or of the threshold for detecting a positioning anomaly in the horizontal plane, and on the basis of the characterization of the positioning error, in the horizontal plane, of the second position \hat{x}⁽²⁾, represented by the covariance matrix C⁽²⁾.

Consequently, the method 100 for consolidating the solution initiates a step (step 104) of estimating a consolidated horizontal protection level HPL^{(CON)} of the computed position \hat{x}⁽¹⁾ as a function of the additional horizontal protection level HPL^{(MON)} of the computed position \hat{x}⁽¹⁾ and of the horizontal protection level HPL⁽¹⁾ of the computed position \hat{x}⁽¹⁾. More specifically, the consolidation method 100 carries out a comparison between the additional horizontal protection level HPL^{(MON)} and the horizontal protection level HPL⁽¹⁾ in order to determine the highest protection level. This comparison can be carried out, for example, according to the following formula:

max(HPL⁽¹⁾,HPL^{(MON)}).

This step 104 of estimating the consolidated horizontal protection level HPL^{(CON)} of the computed position \hat{x}⁽¹⁾ guarantees the protection around the computed position \hat{x}⁽¹⁾ by maximizing the uncertainty linked to the positioning of the computed position \hat{x}⁽¹⁾ induced by possible unlisted errors. Indeed, this estimation step 104 allows the largest radius of the circle to be defined on the horizontal plane comprising the computed position \hat{x}⁽¹⁾, assuring the position of the aircraft in this enlarged circle as well as possible in order to protect against a design error that would lead, for example, to the underestimation of the horizontal protection level HPL⁽¹⁾ and to excessive confidence in the guidance solution. In this way, the method allows a protection radius to be provided at the desired FDAL level since it is consolidated by the use of two different items of information originating from the first sensor and from the second sensor.

There follows a comparison (step 105) of the consolidated horizontal protection level HPL^{(CON)} and of a horizontal alert limit HAL previously defined as a function of the Signal-In-Space standards and as a function of the completed operation. This comparison step 105 is used to check whether or not the consolidated horizontal protection level HPL^{(CON)} is greater than the horizontal alert limit HAL of the aircraft.

The horizontal alert limit HAL can be a physical standard or an operational constraint such as, for example, a maximum distance that must not be exceeded compared to the radius of the circle of the consolidated horizontal protection level HPL^{(CON)}. The International Civil Aviation Organization (ICAO) has thus established standards in relation to the horizontal alert limit as a function of the operations of the aircraft. By way of an example, an NPA operation, typically a landing phase, is normalized by a horizontal alert limit HAL of five hundred and fifty-six meters. For a PA CAT-I (category one Precision Approach) operation, representing one of the most demanding approach phases in terms of navigation performance, the horizontal alert limit according to the ICAO is forty meters. This horizontal alert limit HAL then can be assessed directly by a person skilled in the art as long as it does not contradict the recommendations of the ICAO.

If the consolidated horizontal protection level HPL^{(CON)} is greater than the horizontal alert limit HAL, the consolidation method 100 triggers the alert to interrupt the operation (step 110) allowing an insufficient horizontal performance alert to be shown, i.e. that the space for guaranteeing the position is too large relative to the ongoing operation. It then needs to be interrupted because the operation can cause an immediate danger for the aircraft by alerting the crew members interacting directly with the avionics components.

Otherwise, i.e. if the consolidated horizontal protection level HPL^{(CON)} of the computed position \hat{x}⁽¹⁾ is less than the horizontal alert limit HAL, then a horizontal confirmation (step 106) is carried out of the first position \hat{x}⁽¹⁾ of the aircraft. More specifically, this horizontal confirmation step (step 106) is used to determine whether the operation is feasible in terms of coherence with the various alert limits.

As previously stated, during an NPA approach phase, only lateral guidance is necessary in order to allow the aircraft to land. For this type of operation, the first position \hat{x}⁽¹⁾ of the aircraft then can be validated (step 108) by at least one avionics component as the consolidated position of the aircraft.

Nevertheless, in order to ensure good integrity of the positioning of the aircraft in its environment, and during the phase requiring vertical guidance, typically during APV (Approach and landing Procedures with Vertical Guidance) operations or PA (Precision Approach) operations using a lateral and vertical guide, the method 100 for consolidating the solution can also carry out monitoring in order to observe the integrity of the computed position \hat{x}⁽¹⁾ in accordance with verticality standards.

As previously stated, the first sensor can provide a vertical protection level (VPL⁽¹⁾) representing the vertical assurance space in which the computed position \hat{x}⁽¹⁾ is included for a probability of 1−P_{N}M, using the augmentation system included in the first sensor that complies with the standard related to the integrity risk P_{HMI}. The vertical protection level (VPL⁽¹⁾) represents the half-segment of the vertical axis passing through the aircraft comprising the computed position \hat{x}⁽¹⁾ according to the first sensor.

As previously stated, the second sensor is not necessarily capable of associating the horizontal and vertical protection levels with the estimate of the second position \hat{x}⁽²⁾.

Thus, the method 100 for consolidating the solution can comprise an additional step 1030 of computing an additional vertical protection level VPL^{(MON)} from a vertical deviation, i.e. a deviation in the vertical plane, between the computed position \hat{x}⁽¹⁾ of the aircraft (10) and the second position \hat{x}⁽²⁾ and/or from the threshold for detecting a vertical positioning anomaly, and from the characterization of the positioning error of the second position \hat{x}⁽²⁾ represented by the covariance matrix C⁽²⁾ This step of computing the additional vertical protection level VPL^{(MON)} can be carried out following the step 103 of computing the additional horizontal protection level HPL^{(MON)}, but also can be executed at the same time as the step 103 of computing the additional horizontal protection level HPL^{(MON)} The step 1030 of computing the additional vertical protection level VPL^{(MON)} also can be executed once the horizontal confirmation (step 106) of the computed position \hat{x}⁽¹⁾ is executed.

In a manner similar to the additional horizontal protection level HPL^{(MON)}, the additional vertical protection level VPL^{(MON)} is computed from the vertical deviation between the computed position \hat{x}⁽¹⁾ and the second position \hat{x}⁽²⁾ that is estimated, for example, at the same time as the horizontal deviation during step 101, and/or from the threshold for detecting a positioning anomaly, and from the characterization of the positioning error of the second position \hat{x}⁽²⁾, represented by the covariance matrix C⁽²⁾.

Following the computation 1030 of the additional vertical protection level VPL^{(MON)} the method 100 for consolidating the solution can comprise an additional step 1040 of estimating a consolidated vertical protection level VPL^{(CON)} as a function of the additional vertical protection level VPL^{(MON)} and of the vertical protection level VPL⁽¹⁾. This estimation step 1040 can be executed following the step 104 of estimating the consolidated horizontal protection level HPL^{(CON)} or can be executed at the same time as the step 104 of estimating the consolidated horizontal protection level HPL^{(CON)}. The step 1040 of estimating the consolidated vertical protection level VPL^{(CON)} also can be executed once the horizontal confirmation (step 106) of the computed position \hat{x}⁽¹⁾ is executed, as long as the estimation step 1040 follows the step 1030 of computing the additional vertical protection level VPL^{(MON)}.

Thus, the consolidation method 100 carries out, during this estimation step 1040, a comparison between the additional vertical protection level VPL^{(MON)} of the computed position \hat{x}⁽¹⁾ and the vertical protection level VPL⁽¹⁾ of the computed position \hat{x}⁽¹⁾ in order to determine the highest protection level. This comparison can be carried out, for example, according to the following formula:

max(VPL⁽¹⁾,VPL^{(MON)})

In a manner similar to the consolidated horizontal protection level HPL^{(CON)}, the additional vertical protection level VPL^{(MON)} allows vertical protection to be guaranteed around the computed position \hat{x}⁽¹⁾ by maximizing the uncertainty linked to the positioning of the computed position \hat{x}⁽¹⁾ induced by possible unlisted errors. Indeed, this estimation step 1040 allows the largest half-segment to be defined in the vertical axis passing through the aircraft comprising the computed position \hat{x}⁽¹⁾ ensuring the position of the aircraft as well as possible. In this way, the method allows a protection radius to be provided at the desired FDAL level since it is consolidated by the use of two different items of information originating from the first sensor and from the second sensor.

Following this step 1040 of estimating the consolidated vertical protection level VPL^{(CON)}, the consolidation method 100 comprises an additional step 1050 of comparing the consolidated vertical protection level VPL^{(CON)} and a previously defined vertical alert limit VAL. This comparison step 1050 can be executed following the step 105 of comparing the consolidated horizontal protection level HPL^{(CON)} and the horizontal alert limit HAL or can be executed at the same time as the step 105 of comparing the consolidated horizontal protection level HPL^{(CON)} and the horizontal alert limit HAL. The comparison step 1050 also can be executed once the horizontal confirmation 106 of the computed position \hat{x}⁽¹⁾ is executed, as long as the comparison step 1050 follows the step 1040 of estimating the consolidated vertical protection level VPL^{(CON)}.

As for the comparison step 105, this comparison step 1050 is used to check whether the consolidated vertical protection level VPL^{(CON)} is less than the vertical alert limit VAL of the operation.

As for the horizontal alert limit HAL, the vertical alert limit VAL can be a physical standard or an operational constraint, such as, for example, a maximum distance not to be exceeded compared to the consolidated vertical protection level VPL^{(CON)}. The International Civil Aviation Organization (ICAO) has thus established standards in relation to the vertical alert limit as a function of the operations of the aircraft. For an NPA operation, with the vertical guidance not being dependent on the GNSS, the ICAO has not submitted a vertical alert limit VAL. Nevertheless, for a PA-CAT I (category one Precision Approach) operation, corresponding to one of the most demanding approach and landing phases in terms of navigation performance capabilities, the vertical guidance is necessary. Thus, the ICAO sets the vertical alert limit VAL between ten and thirty-five meters. This vertical alert limit VAL then can be directly assessed by a person skilled in the art, as long as it complies with the standards of the ICAO.

If the consolidated vertical protection level VPL^{(CON)} is greater than the vertical alert limit VAL, the consolidation method 100 triggers the alert (step 110) for interrupting the operation, allowing an anomaly to be shown that is related to a lack of vertical performance, i.e. that the space for guaranteeing the position is too large relative to the ongoing operation. The operation then needs to be interrupted.

Otherwise, i.e. if the consolidated vertical protection level VPL^{(CON)} of the computed position \hat{x}⁽¹⁾ is lower than the vertical alert limit VAL, then a vertical confirmation (step 1060) is carried out for the first position \hat{x}⁽¹⁾ of the aircraft.

The vertical confirmation step 1060 can be executed following the horizontal confirmation step 106 or can be executed at the same time as the horizontal confirmation step 106, as long as the vertical confirmation step 1060 directly or indirectly follows the comparison step 1050.

Thus, during operations requiring lateral and vertical guidance (PA or APV operation), when the horizontal confirmation (step 106) and the vertical confirmation (step 1060) are executed, the first position \hat{x}⁽¹⁾ of the aircraft then can be validated (step 108) by at least one avionics component as the consolidated position of the aircraft.

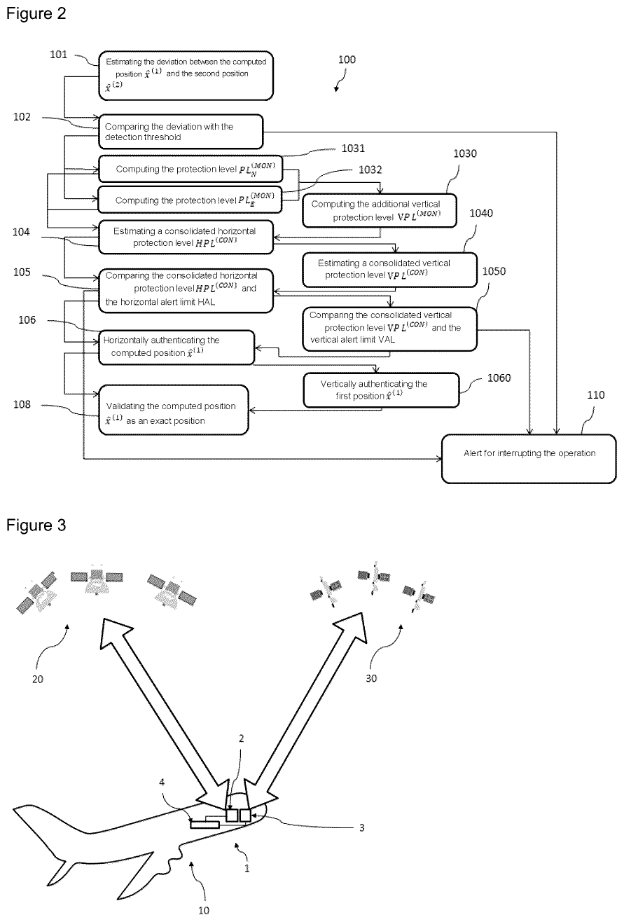

Furthermore, with the aircraft being positioned three-dimensionally, the horizontal plane can be assimilated with a main axis plane, the direction of magnetic north, and with a secondary axis, the direction forming a right angle with the main axis in the horizontal plane in the clockwise direction, i.e. the east direction, the third dimension being the vertical axis. The method can comprise, as shown in FIG. 2, sub-steps 1031 and 1032 of computing an additional horizontal protection level along the main axis, i.e. as a function of the north direction PL_{N}^{(MON)} that represents the position error limit in which the computed position \hat{x}⁽¹⁾ is included relative to the main axis pointing toward magnetic north and an additional horizontal protection level along the secondary axis, i.e. as a function of the east direction PL_{E}^{(MON)} that represents the position error limit in which the computed position \hat{x}⁽¹⁾ is included relative to the secondary axis that points eastward. These sub-steps of computing 1031 the additional horizontal protection level along the main axis PL_{N}^{(MON)} and of computing 1032 the additional horizontal protection level along the main axis PL_{E}^{(MON)} can replace step 103.

Consequently, the step 104 of estimating the consolidated horizontal protection level HPL^{(CON)} of the computed position \hat{x}⁽¹⁾ compares the horizontal protection level HPL⁽¹⁾ with the computed position \hat{x}⁽¹⁾, the additional horizontal protection level along the main axis PL_{N}^{(MON)} and the additional horizontal protection level along the secondary axis PL_{E}^{(MON)}. By way of an example, the estimation 104 of the consolidated horizontal protection level HPL^{(CON)} can be carried out according to the following formula:

HPL^{(CON)}=max(HPL⁽¹⁾,{square root over (PL_{N}^{(MON)})²+(PL_{E}^{(MON)})²)})

In order to be able to execute the method 100 for consolidating the solution, an aircraft 10 can comprise a device 1 for consolidating a satellite navigation solution as shown in FIG. 3. The device 1 for consolidating a satellite navigation solution is able to implement the consolidation method 100. The consolidation device 1 comprises a first sensor 2 or GPS sensor, comprising an augmentation system, able to determine the first position \hat{x}⁽¹⁾ of the aircraft 10, the characterization of the positioning error of the computed position \hat{x}⁽¹⁾ and the horizontal protection level HPL⁽¹⁾. As stated above, the first sensor 2 preferably can be a GPS sensor exclusively communicating with satellites 20 of the GPS constellation. The consolidation device 1 also comprises the second sensor 3 with a different design from the first sensor 2 which is a GPS sensor, i.e. a sensor with a different architecture and operation from that of the architecture and operation of the first sensor 2 and/or for which the detected data are different from the data detected by the first sensor 2. By way of an example, the second sensor 3 can be a Glonass or Galileo sensor communicating only with satellites 30 of the Glonass or Galileo constellation. The second sensor 3 also must have a design level equivalent to the first sensor 2, i.e. respond to the equivalent FDAL criticality standards. In addition, the second sensor 3 is able to determine a second position \hat{x}⁽²⁾ of the aircraft 10 and a characterization of the positioning error of the second position \hat{x}⁽²⁾, represented by the covariance matrix C⁽²⁾ of the positioning errors.

Furthermore, a computer program can also include code instructions for carrying out the steps of the method 100 for consolidating the solution when the program is executed on a computer. However, the invention also can be applicable for a processor-readable recording medium, on which is recorded a program comprising instructions for executing the consolidation method 100 when the program is executed by a processor.

This consolidation of the position of the aircraft 10 can be implemented in a single item of equipment that integrates the first sensor 2 and the second sensor 3, as well as a device 4 gathering the data originating from the first sensor 2 and from the second sensor 3 in order to monitor the computed position \hat{x}⁽¹⁾ of the aircraft 10 and consolidate the associated protection levels before sending out the navigation information to the other avionics components of the aircraft 10.

The consolidation also can be implemented with two distinct items of GNSS equipment, i.e. the first sensor 2 and the second sensor 3 are not integrated in an overall item of equipment, as shown in FIG. 2, providing the device 4 with the information required for consolidating the output of the first sensor 2, namely the computed position \hat{x}⁽¹⁾.

The consolidation device 1 allows, by means of the consolidation method 100, during operations requiring only lateral guidance, the steps of estimating 101, comparing 102, computing 103, estimating 104, comparing 105, horizontally confirming 106, validating 108 and alerting 110 to be executed. In addition, the consolidation device 1 allows, by means of the consolidation method 100, during operations requiring lateral guidance and vertical guidance, in addition to the steps of estimating 101, comparing 102, computing 103, estimating 104, comparing 105, horizontally confirming 106, validating 108 and alerting 110, the steps of computing 1030, estimating 1040, comparing 1050 and vertically confirming 1060 to be executed.

1. A method for consolidating a satellite navigation solution for an aircraft implementing:
a first sensor, comprising an augmentation system, adapted to determine a computed position \hat{x}⁽¹⁾ of the aircraft, a characterization of the positioning error of the computed position \hat{x}⁽¹⁾ and a horizontal protection level HPL⁽¹⁾ of the computed position \hat{x}⁽¹⁾,
a second sensor, with a different design to the first sensor and with a design level equivalent to the first sensor, the architecture and the operation of the second sensor being different from the architecture and the operation of the first sensor and/or data detected by the second sensor being different from the data detected by the first sensor, the second sensor being adapted to determine a second position \hat{x}⁽²⁾ of the aircraft and a characterization of the positioning error of the second position \hat{x}⁽²⁾, the consolidation method comprising the following steps:
a. estimating a horizontal deviation between the computed position \hat{x}⁽¹⁾ of the aircraft and the second position \hat{x}⁽²⁾ of the aircraft,
b. comparing the horizontal deviation with a previously defined detection threshold,
c. if the horizontal deviation is below the detection threshold, computing an additional horizontal protection level HPL^{(MON)} of the computed position \hat{x}⁽¹⁾ from the second position \hat{x}⁽²⁾,
d. estimating a consolidated horizontal protection level HPL^{(CON)} as a function of the additional horizontal protection level HPL^{(MON)} and of the horizontal protection level HPL⁽¹⁾,
e. comparing the consolidated horizontal protection level HPL^{(CON)} and a previously defined horizontal alert limit HAL,
f. if the consolidated horizontal protection level HPL^{(CON)} is less than the horizontal alert limit HAL, horizontally confirming the computed position \hat{x}⁽¹⁾ of the aircraft.

2. The method for consolidating a satellite navigation solution as claimed in claim 1, comprising an additional step, following the step of horizontally confirming the first position \hat{x}⁽¹⁾, of validating the computed position \hat{x}⁽¹⁾ of the aircraft as a consolidated position of the aircraft.

3. The method for consolidating a satellite navigation solution as claimed in claim 1, wherein the additional horizontal protection level HPL^{(MON)} is computed from the horizontal deviation between the computed position \hat{x}⁽¹⁾ of the aircraft and the second position \hat{x}⁽²⁾ of the aircraft and/or from the detection threshold of a positioning anomaly in the horizontal plane, and from the characterization of the positioning error of the second position \hat{x}⁽²⁾.

4. The method for consolidating a satellite navigation solution as claimed in claim 1, wherein the augmentation system of the first sensor is an Airborne Based Augmentation System (ABAS).

5. The method for consolidating a satellite navigation solution as claimed in claim 1, wherein the augmentation system of the first sensor is a Space Based Augmentation System (SBAS) or a Ground Based Augmentation System (GBAS).

6. The method for consolidating a satellite navigation solution as claimed in claim 1, wherein the first sensor is adapted to determine a vertical protection level VPL⁽¹⁾.

7. The method for consolidating a satellite navigation solution as claimed in claim 1, comprising an additional step of computing an additional vertical protection level VPL^{(MON)} from a vertical deviation between the computed position \hat{x}⁽¹⁾ of the aircraft and from the second position \hat{x}⁽²⁾ of the aircraft and/or from the detection threshold of a vertical positioning anomaly, and from the characterization of the positioning error of the second position \hat{x}⁽²⁾ following the step of computing the additional horizontal protection level HPL^{(MON)}.

8. The method for consolidating a satellite navigation solution as claimed in claim 7, comprising an additional step of estimating a consolidated vertical protection level VPL^{(CON)} as a function of the additional vertical protection level VPL^{(MON)} and of the vertical protection level VPL⁽¹⁾ following the step of estimating the consolidated horizontal protection level HPL^{(CON)}, the consolidation method comprising an additional step of comparing the consolidated vertical protection level VPL^{(CON)} and a previously defined vertical alert limit VAL following the step of comparing the consolidated horizontal protection level HPL^{(CON)} and the previously defined horizontal alert limit HAL.

9. The method for consolidating a satellite navigation solution as claimed in claim 8, comprising an additional step of vertically confirming the first position \hat{x}⁽¹⁾ if the consolidated vertical protection level VPL^{(CON)} is less than the vertical alert limit VAL following the horizontal confirmation step.

10. The method for consolidating a satellite navigation solution as claimed in claim 1, wherein the detection threshold is computed as a function of an allocation of continuity.

11. A computer program product, said computer program comprising code instructions for carrying out the steps of the method as claimed in claim 1, when said program is executed on a computer.

12. A processor-readable recording medium on which is recorded a program comprising instructions for executing the method as claimed in claim 1, when the program is executed by a processor.

13. A device for consolidating a satellite navigation solution suitable for implementing the consolidation method as claimed in claim 1, comprising the first sensor comprising an augmentation system, able to determine a computed position \hat{x}⁽¹⁾ of the aircraft, a characterization of the positioning error of the computed position \hat{x}⁽¹⁾ and a horizontal protection level HPL⁽¹⁾, and the second sensor with a different design to the first sensor and with a design level equivalent to the first sensor, able to determine a second position \hat{x}⁽²⁾ of the aircraft and a characterization of the positioning error of the second position \hat{x}⁽²⁾.
